(19) United States
(12) Patent Application Publication
(10) Pub. No.: US 2005/0243115 A1
(43) Pub. Date: Nov. 3, 2005

(54) Control method and controller for a thermal print head and a motor using an encoder

(75) Inventors: Kyung-Pyo Kang, Suwon-si (KR); Hyoung-il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/109,654

(22) Filed: Apr. 20, 2005

(30) Foreign Application Priority Data
Apr. 30, 2004 (KR) 10-2004-0030449

(51) Int. Cl. B41J 29/38

(52) U.S. Cl. 347/17

(57) ABSTRACT

There is provided a control method and a controller for a thermal print head and a motor using an encoder in a thermal printer, in which the movement of the motor is controlled using an output signal of the encoder fitted to the motor and the period for allowing the thermal print head to heat a medium is synchronized with the output signal of the encoder. The controller includes an encoder for converting movement of the motor into an electrical signal and outputting the electrical signal, and a counter unit for counting variations of the electrical signal and generating and outputting a signal for starting the heating of a medium by the thermal print head whenever the number of variations is equal to a predetermined value.

### CROSS-REFERENCE TO RELATED PATENT APPLICATION

This application claims the benefit under 35 U.S.C. 119(a) of Korean Patent Application No. 10-2004-0030449, filed on Apr. 30, 2004, in the Korean Intellectual Property Office, the entire disclosure of which is incorporated herein by reference.

### BACKGROUND OF THE INVENTION

1. Field of the Invention

The present invention relates to a thermal printer. More particularly, the present invention relates to a control method and a controller for a thermal print head and a motor using an encoder in a thermal printer, in which the movement of the motor is controlled by calculating a speed of the motor using an output signal of the encoder fitted to the motor and the period for allowing the thermal print head to heat a medium is synchronized with the output signal of the encoder.

2. Description of the Related Art

In general, thermal printers perform a print job by allowing a thermal print head to heat media. The thermal print head applies heat for a predetermined period and uses a motor as a driving source for supplying the media.

That is, the thermal printers perform the print job by allowing the thermal print head to apply heat to the media for a predetermined period regardless of the speeds at which the media are fed to the thermal print head. In this case, when the feed speed of the media is suddenly varied due to external factors such as external load variations, problems have occurred in that accurate printing resolution cannot be maintained and print quality deteriorates due to the speed of the motor as a driving source for feeding the media.

### SUMMARY OF THE INVENTION

The present invention provides a control method and a controller for a thermal print head and motor using an encoder, in which an accurate printing resolution is provided even when the sheet feed speed is varied due to external load variations, by synchronizing a period for allowing the thermal print head to heat a medium with an output signal of the encoder fitted to the motor, and in which a stable printing operation and high print quality can be obtained by compensating for the variation of the sheet feed speed in real time using the output signal of the encoder.

According to an aspect of the present invention, there is provided a controller for a thermal print head and a motor using an encoder in a thermal printer, the controller comprising an encoder for converting movement of the motor into an electrical signal and outputting the electrical signal; and a counter unit for counting variations of the electrical signal and generating and outputting a signal for initiating the heating of a medium by the thermal print head if the number of variations is equal to a predetermined value. The rising edges of the electrical signal may be counted as the variations of the electrical signal.

The controller may further comprises a reference-value setting unit for setting a reference value of a motor speed which is used to control the movement of the motor; a speed calculating unit for calculating a moving distance of the motor by counting variations of the electrical signal, calculating a speed of the motor by dividing the calculated moving distance by a time spent in counting the number of variations, and outputting the calculated speed of the motor; and a control unit for increasing the speed of the motor when the reference value of the motor speed is greater than the speed output from the speed calculating unit, and reducing the speed of the motor when the reference value is less than the speed output from the speed calculating unit.

According to another aspect of the present invention, there is provided a control method for a thermal print head and a motor using an encoder, the method comprising (a) converting movement of the motor into an electrical signal by using the encoder; (b) counting edges of the electrical signal and (c) allowing the thermal print head to heat a medium when the number of edges are counted in step (b).

In the control method step (a) further comprises (a1) setting a reference value of a motor speed which is used to control the movement of the motor; (a2) calculating a moving distance of the motor by counting the edges of the electrical signal; (a3) calculating a speed of the motor by dividing the calculated moving distance by a time spent in counting the number of edges; (a4) enhancing the speed of the motor when the reference value of the motor speed greater than the speed calculated in step (a3); and (a5) reducing the speed of the motor when the reference value of the motor speed is less than the speed of the motor calculated in step (a3).

The control method may also be embodied as a computer-readable recording medium on which a program allowing a computer to execute the method is recorded.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a structure of a thermal printer using a motor fitted with an encoder;

FIG. 2 is a block diagram illustrating a structure of a controller for a thermal print head using an encoder according to an embodiment of the present invention;

FIG. 3 is a block diagram illustrating a structure of a controller for a motor using an encoder according to an embodiment of the present invention;

FIG. 4 is a flowchart illustrating a procedure of controlling a thermal print head using an encoder according to an embodiment of the present invention;

FIG. 5 is a graph illustrating a relationship between an output signal of the encoder as a rectangular wave and a time point when the thermal print head heats a medium according to an embodiment of the present invention;

FIG. 6 is a graph illustrating a relationship between an output signal of the encoder as a sinusoidal wave and a time point when the thermal print head heats a medium according to an embodiment of the present invention;

FIG. 7 is a flowchart illustrating a procedure of controlling the thermal print head using an encoder and a down counter according to an embodiment of the present invention; and

FIG. 8 is a flowchart illustrating a procedure of controlling a motor using an encoder according to an embodiment of the present invention.

Throughout the drawings, the same element is designated by the same reference numeral or character.

### DETAILED DESCRIPTION OF EXEMPLARY EMBODIMENTS

Hereinafter, a control method and a controller for controlling a thermal print head and a motor using an encoder according to embodiments of the present invention will be described in detail with reference to the accompanying drawings.

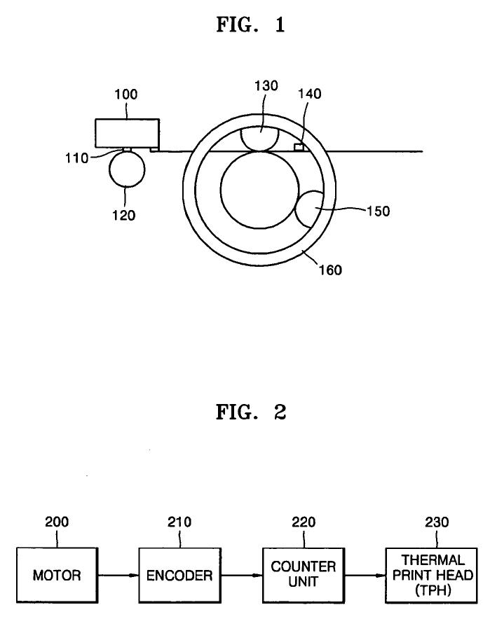

FIG. 1 is a block diagram illustrating a structure of a thermal printer using a motor fitted with an encoder. The thermal printer comprises a thermal print head 100, a thermal print head nozzle 110, a thermal print head roller 120, a sheet input roller 130, a sheet sensor 140, a motor 150, and an encoder 160.

The thermal print head 100 heats a medium for a predetermined period in the thermal printer. The thermal print head nozzle 110 supplies ink required for a printing job to the thermal print head roller 120. The thermal print head roller 120 attaches the ink to the medium by using the heat applied from the thermal print head 100 and outputs the medium. The sheet input roller 130 moves the medium by using the motor 150 as a driving source. The sheet sensor 140 senses the position of the medium. The motor 150 serves as a driving source supplying the medium to the thermal print head 100. The encoder 160 converts movement of the motor 150 into an electrical signal and then outputs the electrical signal.

FIG. 2 is a block diagram illustrating a structure of a controller for the thermal print head using an encoder according to the present invention. The controller comprises a motor 200, an encoder 210, a counter unit 220, a thermal print head 230.

The motor 200 moves a sheet supplied for a printing job to the thermal print head 230. The encoder 210, which is fitted to the motor 200, converts the movement of the motor 200 into an electrical signal and then outputs the electrical signal. The counter unit 220 counts variations (edges) of the electrical signal output from the encoder 210 and outputs a signal (heat signal) for starting the heating of the thermal print head every time the number of variations of the output signal of the encoder reaches a predetermined value. When the output signal of the encoder is a rectangular wave, the counter unit 220 may count rising edges, dropping edges, or constant portions of the output signal of the encoder as the variations of the output signal of the encoder.

The thermal print head 230 applies heat to the supplied sheet in response to the heat signal output from the counter unit 220.

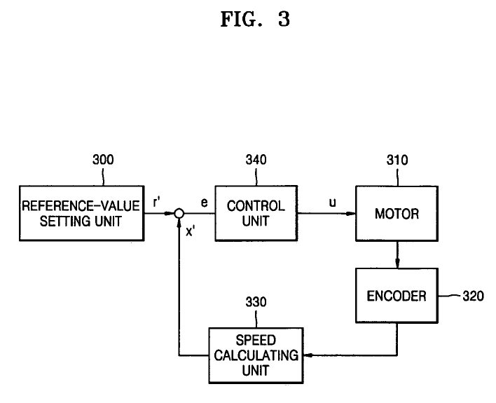

FIG. 3 is a block diagram illustrating a structure of a controller for a motor using an encoder according to an embodiment of the present invention. The controller for a motor comprises a reference-value setting unit 300, a motor 310, an encoder 320, a speed calculating unit 330, and a control unit 340.

The reference-value setting unit 300 sets a reference value of the motor speed, which is used to control movement of the motor 310, and then outputs the set reference value. The motor 310 operates in accordance with the amount of current output from the control unit 340 and supplies the medium to the thermal print head. The encoder 320 converts the movement of the motor 310 into an electrical signal and then outputs the electrical signal.

The speed calculating unit 330 counts the edges of the output signal of the encoder 320, and calculates a moving distance of the motor 310 by multiplying the number of edges by a predetermined moving distance between edges, calculates the speed of the motor 310 by dividing the calculated moving distance by the time spent for counting the edges, and then outputs the calculated speed.

When the reference value of the motor speed output from the reference-value setting unit 300 is greater than the motor speed output from the speed calculating unit 330, the control unit 340 increases the amount of current supplied to the motor 310, thereby enhancing the speed of the motor 310. When the reference value of the motor speed is less than the motor speed output from the speed calculating unit 330, the control unit 340 decreases the amount of current supplied to the motor 310, thereby reducing the speed of the motor 310. The control unit 340 may be embodied as PID, PI, P, an adaptive controller or any other suitable control device.

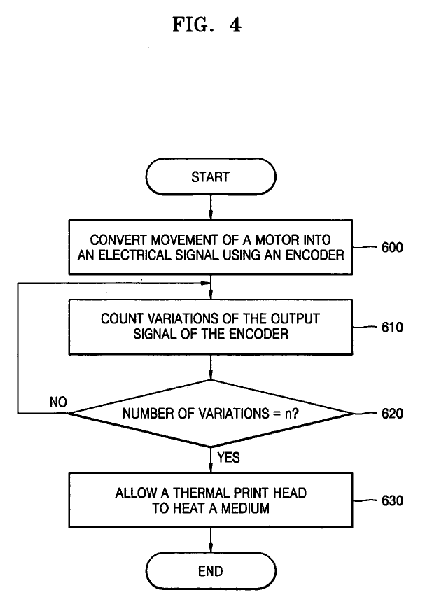

FIGS. 4 to 8 are flowcharts illustrating operations of a controller for controlling a thermal print head and a motor using an encoder according to an embodiment of the present invention. The present invention will be now described with reference to the figures.

FIG. 4 is a flowchart illustrating a procedure of controlling a thermal print head using an encoder according to an embodiment of the present invention. First, the movement of the motor 200 is converted into an electrical signal by using the encoder 210 at step 600. The variations of the output signal of the encoder 210 are monitored and the number of variations of the output signal of the encoder 210 is counted at step 610. When the output signal of the encoder is a rectangular wave, rising edges, dropping edges, or constant portions, the output signal of the encoder may be counted as the variations of the output signal of the encoder at step 610. When the output signal of the encoder is a sinusoidal wave, the maximum value or the minimum value of the output signal of the encoder may be counted.

Then, it is determined whether the number of variations counted in operation 610 reaches a predetermined value n at step 620. When the number of variations does not reach the predetermined value n, steps 610 to 620 are repeated until the number of variations of the output signal of the encoder reaches the predetermined value n. Then, the thermal print head 230 heats the medium at step 630).

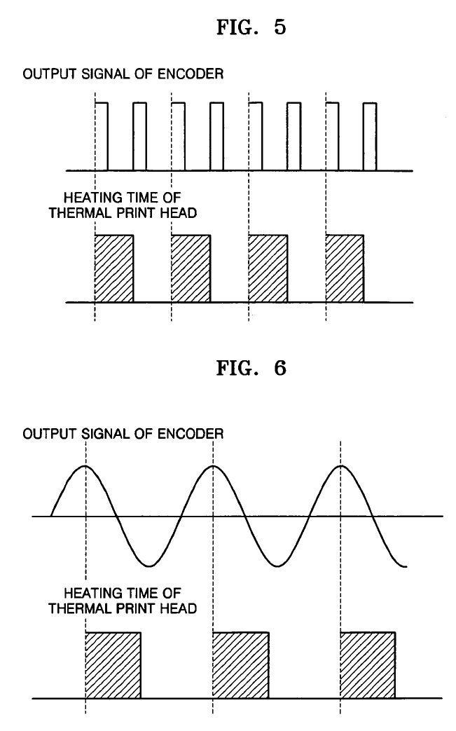

FIG. 5 is a graph illustrating a relationship between the output signal of the encoder as a rectangular wave and the time point when the thermal print head heats the medium according to an embodiment of the present invention, where n is set to 2 such that the thermal print head 230 heats the medium whenever the number of rising edges counted by the counter unit 220 is equal to 2.

FIG. 6 is a graph illustrating a relationship between the output signal of the encoder as a sinusoidal wave and the time point when the thermal print head heats the medium according to an embodiment of the present invention. When the output signal of the encoder 210 is a sinusoidal wave, the number of the maximum or the minimum values of the output signal are counted by monitoring the maximum or minimum values of the output signal where the differentiated coefficient is zero, and the counter unit 220 can generate and output a signal for starting the heating job of the thermal print head 230 whenever the number of the maximum or minimum values is equal to a predetermined value.

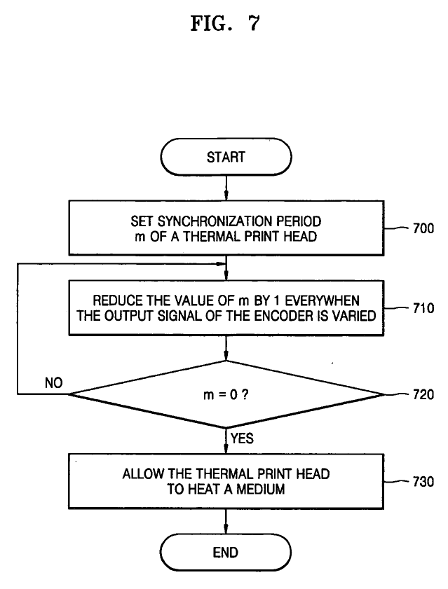

FIG. 7 is a flowchart specifically illustrating the procedure of controlling the thermal print head using an encoder and a down counter according to an embodiment of the present invention. First, a period m, when the thermal print head 230 is synchronized with the output signal of the encoder, is set at step 700. The variations of the output signal of the encoder 210, which is obtained by converting the movement of the motor into an electrical signal, are monitored and the value of m is decreased by 1 every variation of the output signal of the encoder at step 710. When the output signal of the encoder is a rectangular wave, rising edges, dropping edges, or constant portions of the output signal of the encoder may be counted as the variations of the output signal of the encoder at step 710. When the output signal of the encoder is a sinusoidal wave, the maximum value or the minimum value of the output signal of the encoder may be counted.

Then, it is checked whether the value of m is equal to 0 at step 720. When the value of m is not equal to 0, operation 710 is repeated until the value of m is equal to 0. Then, the thermal print head 230 heats the medium at step 730.

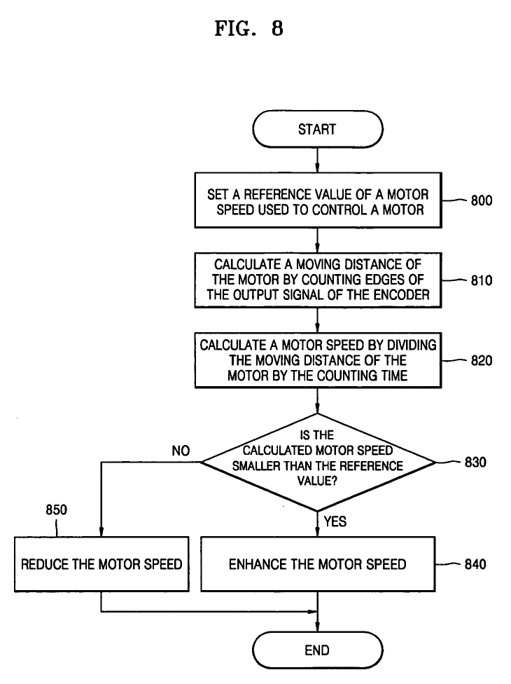

FIG. 8 is a flowchart illustrating a procedure of controlling a motor using an encoder according to an embodiment of the present invention. First, a reference value of the motor speed, which is used to control the motor 310, is set at step 800. The number of edges of the output signal of the encoder 320 is counted by monitoring the edges of the output signal, and an actual moving distance of the motor 310 is calculated by multiplying the counted number of edges by a predetermined moving distance of the motor between edges at step 810. Then, the moving speed of the motor 310 is calculated by dividing the calculated moving distance of the motor 310 by the time spent in counting the number of edges at step 820.

Then, it is determined whether the moving speed of the motor is smaller than the set reference value of the motor speed at step 830. When the moving speed of the motor is less than the reference value, the amount of current supplied to the motor 310 is increased, thereby enhancing the speed of the motor 310 at step 840. When the moving speed of the motor is greater than the reference value, the amount of current supplied to the motor 310 is decreased, thereby reducing the speed of the motor 310 at step 850.

As described above, in the controller and the control method for a thermal print head and a motor using an encoder according to an embodiment of the present invention, it is possible to provide an accurate printing resolution even when the speed of feeding a medium is varied due to external load variations, by synchronizing the period for allowing the thermal print head to heat the medium with the output signal of the encoder fitted to the motor when a thermal printer is allowed to operate using the motor as a driving source. It is also possible to maintain a constant the speed for feeding a sheet by calculating the actual moving speed of the motor using the output signal of the encoder fitted to the motor and compensating for the variation of the motor speed in real time.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the embodiment of the present invention can be easily construed by programmers skilled in the art to which the present invention pertains.

While the present invention has been particularly shown and described with reference to an exemplary embodiment thereof, it should be understood by those skilled in the art that various changes in form and details may be made therein without departing from the spirit and scope of the invention as defined by the appended claims. The exemplary embodiment should be considered in a descriptive sense only and not for purposes of limitation. Therefore, the scope of the invention is defined not by the detailed description of the invention but by the appended claims, and all differences within the scope will be construed as being included in the present invention.

1. A controller for a thermal print head and a motor using an encoder in a thermal printer, the controller comprising:
an encoder for converting movement of the motor into an electrical signal and outputting the electrical signal; and
a counter unit for counting variations of the electrical signal and generating and outputting a signal for initiating the heating of a medium by the thermal print head whenever the number of variations is equal to a predetermined value.

2. The controller according to claim 1, wherein rising edges of the electrical signal are counted as the variations of the output signal of the encoder.

3. The controller according to claim 1, further comprising:
a reference-value setting unit for setting a reference value of a motor speed which is used to control the movement of the motor;
a speed calculating unit for calculating a moving distance of the motor by counting edges of the electrical signal, calculating a speed of the motor by dividing the calculated moving distance by a time spent in counting the number of edges, and outputting the calculated speed of the motor; and
a control unit for increasing the speed of the motor when the reference value of the motor speed is greater than the speed output from the speed calculating unit, and reducing the speed of the motor when the reference value is less than the speed output from the speed calculating unit.

4. The controller according to claim 1, wherein the medium comprises paper.

5. The controller according to claim 1, wherein the electrical signal comprises one of a sinusoidal signal and a square wave.

6. The controller according to claim 1, wherein falling edges of the electrical signal are counted as the variations of the output signal of the encoder.

7. The controller according to claim 1, wherein at least one of constant portions and peaks of the electrical signal are counted as the variations of the output signal of the encoder.

8. A control method for a thermal print head and a motor using an encoder, the method comprising:
(a) converting movement of the motor into an electrical signal by using the encoder;
(b) counting variations of the electrical signal; and
(c) allowing the thermal print head to heat a medium when the number of variations counted in step (b) equals a predetermined threshold.

9. The method according to claim 8, wherein step (a) further comprises the steps of:
(a1) setting a reference value of a motor speed which is used to control the movement of the motor;
(a2) calculating a moving distance of the motor by counting the variations of the electrical signal;
(a3) calculating a speed of the motor by dividing the calculated moving distance by a time spent in counting the number of variations of the electrical signal;
(a4) increasing the speed of the motor when the reference value of the motor speed is greater than the speed calculated in step (a3); and
(a5) reducing the speed of the motor when the reference value of the motor speed is less than the speed of the motor calculated in step (a3).

10. The method according to claim 8, wherein the variations of the electrical signal comprise rising edges of the electrical signal.

11. The method according to claim 8, wherein the variations of the electrical signal comprise falling edges of the electrical signal.

12. The method according to claim 8, wherein the variations of the electrical signal comprise at least one of constant portions and peaks of the electrical signal.

13. The method according to claim 8, wherein the medium comprises paper.

14. A computer-readable recording medium of instructions for controlling a thermal print head and a motor using an encoder, comprising:
a first set of instructions, adapted to control the encoder to convert movement of the motor into an electrical signal and output the electrical signal; and
a second set of instructions, adapted to control a counter unit to count variations of the electrical signal and generate and output a signal to initiate the heating of a medium by the thermal print head whenever the number of variations is equal to a predetermined value.

15. The computer-readable medium of instructions of claim 14, further comprising:
a third set of instructions, adapted to control a reference-value setting unit to set a reference value of a motor speed which is used to control the movement of the motor;
a fourth set of instructions, adapted to control a speed calculating unit to calculate a moving distance of the motor by counting edges of the electrical signal, calculate a speed of the motor by dividing the calculated moving distance by a time spent in counting the number of edges, and output the calculated speed of the motor; and
a fifth set of instructions, adapted to control a control unit to increase the speed of the motor when the reference value of the motor speed is greater than the speed output from the speed calculating unit, and reduce the speed of the motor when the reference value is less than the speed output from the speed calculating unit.

16. The computer-readable medium of instructions of claim 14, wherein the first set of instructions is adapted to control the encoder to count rising edges of the electrical signal as the variations of the output signal of the encoder.

17. The computer-readable medium of instructions of claim 14, wherein the first set of instructions is adapted to control the encoder to count falling edges of the electrical signal as the variations of the output signal of the encoder.

18. The computer-readable medium of instructions of claim 14, wherein the first set of instructions is adapted to control the encoder to count at least one of constant portions and peaks of the electrical signal as the variations of the output signal of the encoder.
